(19) United States
(12) Patent Application Publication
(10) Pub. No.: US 2010/0126343 A1
(43) Pub. Date: May 27, 2010

(54) Electrically Enhanced Air Filter Apparatus With A Perpendicular Field Ionizer

(75) Inventors: Donald John Enzinna, Lockport, NY (US); Ilya Reyzin, Williamsville, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/323,021

(22) Filed: Nov. 25, 2008

(51) Int. Cl. B03C 3/38

(52) U.S. Cl. 95/79; 96/62; 96/63; 95/70; 96/66; 96/67; 96/77

(57) ABSTRACT

An electrically enhanced air filter apparatus for filtering particles from moving air is described. The apparatus includes a filter arranged so particles approach the filter a filter speed and pass through an ionizer at an ionizer speed, and is configured so the filter speed is less than the ionizer speed. The ionizer is arranged to guide the moving air in an ionizer airflow direction and generates an ionizing electric field having ionizer field direction substantially perpendicular to the ionizer airflow direction.

### TECHNICAL FIELD OF INVENTION

The invention relates to electrically enhanced air filter apparatus that ionize particles in the air for improving the efficiency of the filter to remove and retain the particles from the air. In particular, the electrically enhanced air filter apparatus has an ionizer that generates an electric field having a direction perpendicular to the direction of the air flowing through the ionizer at an ionizer speed to ionize the particles in the air, and then passes the air through a filter element at a filter speed less than the ionizer speed, thereby increasing the efficiency of the filter.

### BACKGROUND OF INVENTION

It is known to ionize particles in air prior to filtering to improve the efficiency of a filter. Particles are ionized by passing through an ionizing field having sufficient electric field strength. It is believed that minimizing the speed that the ionized particles approach a filter improves filter efficiency, thereby encouraging large filter areas. Electrically enhanced air filters with ionizer areas similar to the filter areas generate ionizing fields that are spread out, thereby requiring a high ionizing voltage source to establish an ionizing field. Furthermore, arrangements of needle and brush ionizers may not create a uniform ionizing field, so the particles in the air may not be uniformly ionized. Thus, electrically enhanced air filters are compromised with respect to size and effectiveness to balance the needs of electric field strength, ion current, airflow, packaging constraints, and aesthetics.

What is needed is a compact electrically enhanced air filter apparatus having a smaller ionizer that creates an ionizing field to ionize air particles moving through the ionizer at an ionizer speed and then reduces the speed of the particles approaching the filter.

### SUMMARY OF THE INVENTION

In accordance with this invention, an electrically enhanced air filter apparatus is provided for filtering particles from moving air. The apparatus has a housing that defines an inlet, an outlet, and a filter chamber between the inlet and the outlet. Air moves through the housing by moving into the inlet, through the filter chamber and out of the outlet. Within the housing is a filter disposed in a first passageway that defines a filter area. The filter is adapted to filter ionized particles from air moving through the filter. The apparatus also has an ionizer disposed in a second passageway within the filter chamber between the filter and the inlet. The area of the ionizer is smaller than the filter area. The second passageway guides the air in an ionizer airflow direction. The ionizer is configured to establish an electric field to form an ionizing curtain across the second passageway, where the ionizing curtain is arrayed along a plane substantially perpendicular to the ionizer flow direction. The configuration is effective to ionize particles moving through the ionizing curtain.

An embodiment of a method of filtering particles from air utilizing an air filtering apparatus comprising an ionizer generating an ionizing curtain having an ionizer field direction and a filter is described. The method includes moving a quantity of air through the ionizer in an ionizer airflow direction substantially perpendicular to the ionizing curtain and substantially perpendicular the ionizer field direction at an ionizer speed, and moving air through the filter at a filter speed less than the ionizer speed.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a sectional side-view of an electrically enhanced air filter apparatus housing with a ionizer and a fan of a type preferred in the practice of this invention;

FIG. 2 is a detailed sectional side-view of the ionizer in FIG. 1;

FIG. 3 is a detailed sectional top-view of the ionizer in FIG. 1; and

FIG. 4 is a perspective view of the ionizer and a portion the housing in FIG. 1.

### DETAILED DESCRIPTION OF INVENTION

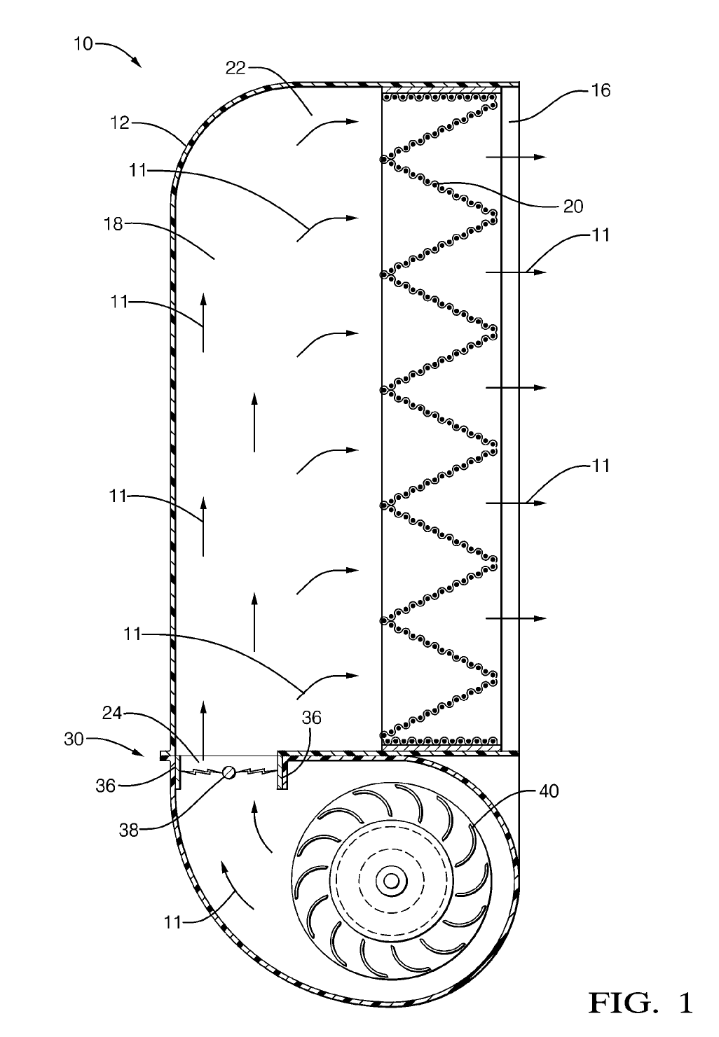

In accordance with a preferred embodiment of this invention, FIG. 1 shows an electrically enhanced air filter apparatus 10 for filtering particles from air moving in an airflow direction 11. The air is moved by a fan 40 through an ionizer 30, in which particles in the air are ionized, and then through a filter 20 where particles adhere to the filter and are thereby removed from the air. A housing 12 defines an inlet 14, shown in FIG. 4, for supplying air to fan 40, an outlet 16, for expelling filtered air from the filter apparatus and a filter chamber 18 between inlet 14 and outlet 16. Housing 12 provides a guide for the air such that air moves in airflow direction 11 into inlet 14, through ionizer 30 and filter 20, and out of outlet 16. The housing is preferably made from an electrically isolative material so the housing does not dissipate electric charge created by the ionizer. The housing is configured so that all of the air entering inlet 14 passes through the ionizer 30, through filter 20, and exits outlet 16, whereby none of the particles can bypass either ionizer 30 or filter 20.

Housing 12 defines filter chamber 18 that includes filter 20 disposed in a first passageway 22. Filter 20 is formed of a filter media selected to filter or entrap particles in the air being filtered. The filter media selected has characteristics that cooperate with the particles being ionized to more efficiently remove the particles from the air. An exemplary filter media is High Air Flow (HAF) Air Filtration Media sold by the 3M corporation. Filter 20 shown in FIG. 1 has a planar configuration and is arranged in the housing so that air flows through the filter in a direction substantially perpendicular to the plane established by the body of the filter. Alternate filter configurations are possible such as circular filter elements similar to those found in automotive engine air-cleaner assemblies. Filter 20 and first passageway 22 define a cross-sectional area that determines a filter area. Filter areas proposed for an electrically enhanced air filter apparatus are in a range of about 0.1 square meters to about 4 square meters. An exemplary filter area for an electrically enhanced air filter apparatus for filtering air in a room is 0.25 square meters, where filter 20 has a square shape of 0.5 m on each side.

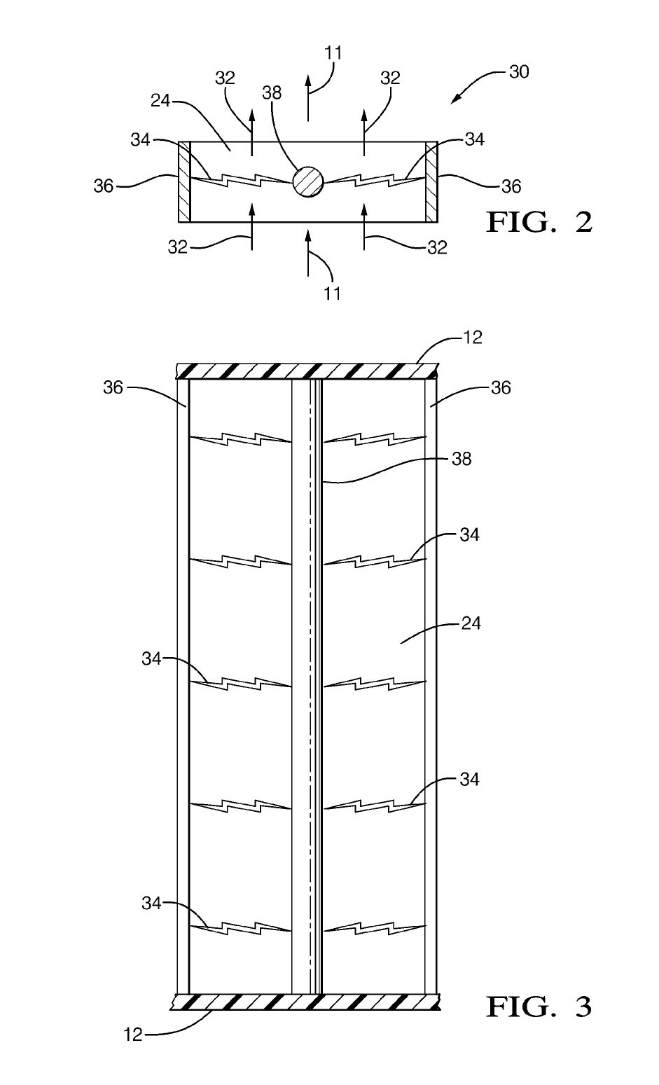

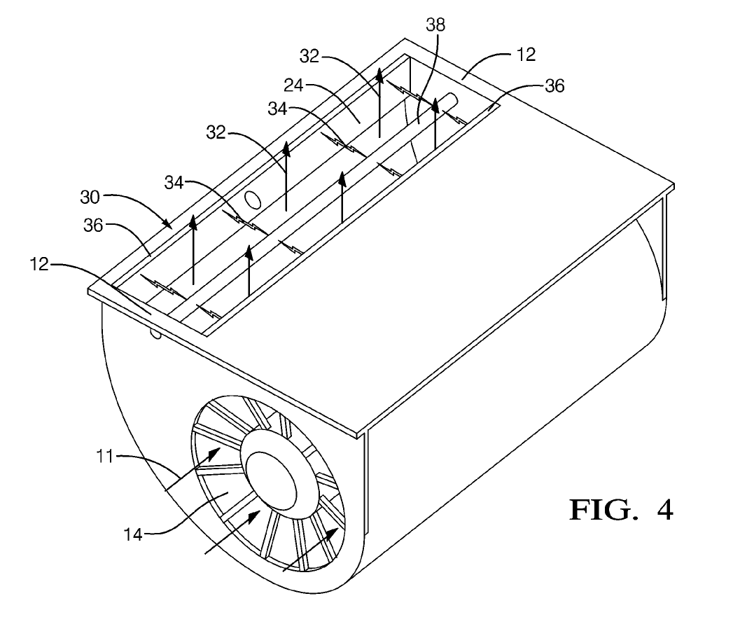

Filter chamber 18 also includes ionizer 30 disposed in a second passageway 24 between inlet 14 and filter 20. Ionizer 30 and second passageway 24 define a cross-sectional area that determines the ionizer area. FIGS. 2 and 3 are detailed views of ionizer 30 having an ionizer electrode 38 and a reference electrode 36. The electrodes 38 and 36 are arranged to generate an ionizing electric field depicted by jagged lines 34 in response to a sufficient voltage difference applied from the ionizer electrode 38 to the reference electrode 36. In general, ionizers operate by applying a sufficient voltage from an ionizer electrode to a reference electrode to establish an ionizing electric field and create a cloud of ions within the electric field that have a sufficient ion density to ionize particles passing through the cloud. The arrangement shown in FIGS. 2 and 3 creates an ionizing electric field that forms an ionizing cloud across the second passageway arrayed along a plane substantially perpendicular to an ionizer airflow direction as depicted by ionizer flow arrows 32. Second passageway 24 guides airflow direction 11 to flow in ionizer airflow direction depicted by ionizer flow arrows 32 substantially perpendicular to the ionizing electric field depicted by jagged lines 34. With this configuration, particles are ionized by passing through an ionizing cloud resembling a curtain across the second passageway 24 created by the ionizer 30.

FIG. 3 is a detailed sectional top-view of ionizer 30 showing ionizer electrode 38 and reference electrode 36 having substantially the same length. Portions of housing 12 cooperate with reference electrode 36 to define second passageway 24. The electric field depicted by jagged lines 34 extends from ionizer electrode 38 to reference electrode 36, and the ionizer airflow direction is substantially normal to the page of the drawing, and substantially perpendicular to electric field depicted by jagged lines 34. At any position between the electrodes, the ionizing electric field is substantially uniform across the width of the ionizer, the width being a direction parallel to the electrodes. This generates an ionizing curtain having an ion density that is substantially uniform along a line parallel to the electrodes. With this arrangement, the particles passing through the filter apparatus are exposed to a more uniform ion density and are thereby more uniformly ionized. The ionizer can be smaller than comparably effective needle type ionizers because the electrode arrangement generates a more organized electric field when compared to the omni-directional kind of field generated by a needle type electrode. Thus, the ionizing electric field generated by the ionizer arrangement in FIGS. 1-3 is effective to ionize particles in the air moving through the ionizer at speeds higher than the preferred speed for particles approaching the filter. Furthermore, the smaller ionizer allows for a more compact electrically enhanced air filter apparatus and can use lower voltages across the electrodes to be sufficient to establish an ionizing electric field.

Ionizer 30 is shown having an area rectangular in shape where rectangle size is determined by a minor axis or height and a major axis or width greater than the height. Having a rectangle shape with the electrode arrangement shown provides a more consistent electric field intensity across the width of the ionizer and therefore a more uniform ion density. Exemplary values for the height and the width are 40 mm and 500 mm respectively, thereby defining an ionizer area of 0.02 meters square. Reference electrode 36 is formed by two rectangular plates made of conductive material having plate lengths substantially equal to the width of the ionizer and electrically connected to each other. The plates are arranged parallel to each other on opposing widthwise walls of the ionizer upon the surface of second passageway 24. The ionizer electrode 38 is arranged parallel to and intermediate the plates forming reference electrode 36 so the ionizing electric field forms a uniform ionizing curtain through which particles in the air pass. Electrodes 36 and 38 are electrically coupled to a voltage source (not shown), typically with wires (not shown), and a voltage is applied to the electrodes effective to establish an ionizing electric field. The rectangular shape allows the distance between the ionizing electrode and reference electrode to be adjusted to provide an electric field intensity sufficient to create an ionizing electric field for a given applied voltage. A suggested range of sufficient electric field intensity values is about 400 kV/m to about 1000 kV/m. An exemplary electric field intensity value that creates an ionizing electric field in the electrically enhanced air filter apparatus shown in FIG. 1 is about 600 kV/m.

Ionizer electrode 38 in this embodiment is formed of wire. Smaller diameter wires have greater ionizing efficiencies because of increased corona discharge effects, while larger diameter wires have greater durability. A range of exemplary ionizer electrode 38 wire diameters is about 0.001 mm to about 0.1 mm. An optimum ionizer electrode 38 wire diameter for an electrically enhanced air filter apparatus similar to the design shown in the figures is about 0.025 mm. An ionizer configured as shown having height of 40 mm, a width of 500 mm, a wire diameter of 0.025 mm, a field intensity of 600 kV/m is suitable for ionizing typical indoor room air at a flow rate of about 150 cubic feet per minute. Based on these dimensions, a voltage of about 12 kV applied across the 20 mm distance between the electrodes is a sufficient voltage to generate a field intensity of 600 kV/m. If the flow rate is increased, the exemplary ionizer may become less effective. If the flow rate is decreased, the exemplary ionizer may be physically larger than necessary.

A ratio of the filter area to the ionizer area is an electrically enhanced air filter apparatus design variable that can be varied. The ratio is adjusted to the area of ionizer 30 occupies as small an area as possible while still being effective to ionize the particles in the air traveling through the ionizer at an ionizer speed. The ionizer speed is determined by the area of the ionizer and the volume or mass of air passing through the electrically enhanced air filter apparatus. As the ionizer speed increases, ionizer 30 becomes less effective, so there is an upper limit for the ionizer speed based on a desired effectiveness. The filter area is also determined by a desired filter effectiveness based on a filter speed of a particle approaching filter 20. The effectiveness of filtering is increased by increasing the filter area thereby reducing the filter speed of the particles approaching the filter. There is an upper limit for the area of filter 20 based on a desired maximum size of the electrically enhanced air filter apparatus. An exemplary range of a ratio of filter area to ionizer area is 6:1 to 20:1. For the electrically enhanced air filter apparatus in FIG. 1, a ratio of 10:1 has been suggested.

FIG. 1 also shows fan 40 as part of electrically enhanced air filter apparatus 10. The exemplary fan shown in FIG. 1 is a squirrel cage type fan. Alternate embodiments of an electrically enhanced air filter apparatus could use any device capable of moving air such as an axial fan like those found in home computers. Alternately, the fan could be located remote from the housing and coupled to the housing by ducting, or coupled to the outlet and configured to draw air through the filter chamber. FIG. 4 is a perspective view of the lower portion of FIG. 1 and shows the relative orientation of ionizer 30, electric field depicted by jagged lines 34, and inlet 14. The air flow is established by the fan and the rate of air flow is at least a function of fan speed or fan effort. If the fan speed is increased, more air moves through the air filter apparatus, but the efficiency of the filter apparatus may decrease. If a room has a relatively large number of particles in the air, then a higher fan speed may be desirable to more quickly filter a greater portion of the air in the room at a reduced efficiency. Alternately, if the air has a relatively low number of particles, than a lower fan speed may be desirable to increase the efficiency of the filter system and reduce the amount of fan noise generated by the filter system.

FIG. 1 shows filter 20 as a planar element having a filter plane, and the housing is configured so the ionizer airflow direction depicted by ionizer flow arrows 32 is substantially parallel to and offset from the filter plane. This arrangement reduces the size of electrically enhanced air filter apparatus 10. Alternately, the arrangement allows for a larger area filter 20 for a given electrically enhanced air filter apparatus size, thereby increasing filtering efficiencies.

Thus, an electrically enhanced air filter apparatus having a compact ionizer 30 that generates an ionizing electric field and reduces the filter speed of the particles approaching filter 20 is provided. The arrangement of ionizer 30 creates a uniform ionizing electric field by establishing an ionizing curtain perpendicular to the direction of the particles flowing through ionizer 30. The compactness of the ionizer reduces the voltage requirements necessary to generate an electric field intensity sufficient to ionize the particles in the air flowing therethrough. Furthermore, the cross-sectional area of the filter 20 is larger than the cross sectional area of the ionizer 30. Thus, for a given volume or mass of air flowing through filter 20, increasing the cross-sectional area of the filter reduces the filter speed of particles approaching the filter, thereby increasing the probability that a particle will be intercepted by the filter and reducing the probability that the particle will pass through the filter.

While this invention has been described in terms of the preferred embodiments thereof, it is not intended to be so limited, but rather only to the extent set forth in the claims that follow.

We claim:

1. An electrically enhanced air filter apparatus for filtering particles from air comprising:
a housing defining an inlet, an outlet, and a filter chamber between the inlet and the outlet, wherein air moves into the inlet, through the filter chamber and out of the outlet;
a filter disposed in a first passageway within the filter chamber, defining a filter area, and adapted to filter particles from air moving toward the filter at a filter speed;
an ionizer disposed in a second passageway within the filter chamber between the filter and the inlet, defining an ionizer area smaller than the filter area, the second passageway guiding the air in an ionizer airflow direction at an ionizer speed, said ionizer configured to establish an ionizing electric field to form an ionizing curtain across the second passageway, said ionizing curtain arrayed along a plane substantially perpendicular to the ionizer flow direction and effective to ionize particles moving through the ionizing curtain, and wherein the filter speed is less than the ionizer speed, thereby increasing the efficiency of the filter.

2. The apparatus of claim 1, wherein
the housing is formed of an electrically isolative material.

3. The apparatus of claim 1, wherein
the housing is configured so all of the air entering the inlet passes through the ionizer, all of the air passing through the ionizer passes through the filter, and all of the air passing through the filter exits the outlet.

4. The apparatus of claim 1, wherein
the apparatus further comprises a fan connected to the inlet.

5. The apparatus of claim 1, wherein
the filter is formed of a filter media effective for entrapping ionized particles, thereby removing ionized particles from in the air moving through the filter.

6. The apparatus of claim 1, wherein
the filter is a planar element having a filter plane, and
the housing is configured so the ionizer airflow direction is substantially parallel to and offset from the filter plane.

7. The apparatus of claim 1, wherein
the filter area is in a range of about 0.1 square meters to about 4 square meters.

8. The apparatus of claim 7, wherein
the filter area is about 0.25 square meters

9. The apparatus of claim 1, wherein
a ratio of the filter area to the ionizer area is in a range of about 6:1 to about 20:1.

10. The apparatus of claim 9, wherein
the ratio of the filter area to the ionizer area is about 10:1.

11. The apparatus of claim 1, wherein
the second passageway is substantially a rectangular shape having a height and a width greater than the height.

12. The apparatus of claim 11, wherein
the ionizer comprises a reference electrode having a rectangular first plate and a rectangular second plate, each plate having a plate length corresponding to the major axis of each plate and substantially equal to the width of the second passageway, each plate contacting opposing widthwise sides of the second passage way and separated by the height, and the reference electrode plates arranged substantially parallel the ionizer airflow direction.

13. The apparatus of claim 12, wherein
the ionizer further comprises an ionizer electrode formed of a wire having a wire length substantially equal to the plate length, a longitudinal axis arranged substantially parallel to and substantially intermediate the first and second plates and substantially perpendicular to the ionizer airflow direction, the arrangement of the reference electrode and ionizer electrode effective to establish an ionizer field direction substantially perpendicular to the ionizer airflow direction.

14. The apparatus of claim 11, wherein the second passageway has a height of about 40 mm and a width of about 500 mm.

15. The apparatus of claim 14, wherein
the wire has a diameter of about 0.001 mm to 0.1 mm.

16. The apparatus of claim 15, wherein
the wire has a diameter of about 0.025 mm.

17. The apparatus of claim 1, wherein
the ionizer has a value of electric field intensity in a range of about 400 kV/m to 1000 kV/m.

18. The apparatus of claim 17, wherein
the ionizer has a value of electric field intensity of about 600 kV/m.

19. A method of filtering particles from air utilizing an air filtering apparatus comprising an ionizer generating an ionizing electric filed having an ionizer field direction, and a filter, said method comprising:
moving a quantity of air through the ionizer in an ionizer airflow direction substantially perpendicular to the ionizing field direction at an ionizer speed; and
moving the quantity of air through the filter at a filter speed less than the ionizer speed.

20. The method of claim 19, wherein
a ratio of the first speed to the second speed is in a range of about 6:1 to about 20:1.
